(19) United States
(12) Patent Application Publication
(10) Pub. No.: US 2008/0181427 A1
(43) Pub. Date: Jul. 31, 2008

(54) HORN TONE SYSTEM

(76) Inventor: Joseph Risolia, Miami Beach, FL (US)

Correspondence Address: ADVANTIA LAW GROUP, 9035 SOUTH 1300 EAST, SUITE 200, SANDY, UT, 84094, US

(21) Appl. No.: 12/018,064

(22) Filed: Jan. 22, 2008

Related U.S. Application Data
(60) Provisional application No. 60/881,597, filed on Jan. 22, 2007.

(51) Int. Cl. H04R 27/00

(52) U.S. Cl. 381/82

(57) ABSTRACT

A horn tone system, including a speaker module configured to broadcast audio; a CPU module in communication with the speaker module and configured to control and store audio information; and a communication module in communication with the CPU module and configured to receive control and audio information.

### CROSS-REFERENCE TO RELATED APPLICATIONS

This invention claims priority, under 35 U.S.C. § 120, to the U.S. Provisional Patent Application No. 60/881,597 to Joseph Risolia and filed on 22 Jan. 2007, which is incorporated by reference herein.

### BACKGROUND OF THE INVENTION

1. Field of the Invention

The present invention relates to vehicle signals, specifically to horn tone systems.

2. Description of the Related Art

In the related art, it has been known to use custom vehicle tones/horns. Some improvements have been made in the field. Examples of references related to the present invention are described below, and the supported teachings of each reference are incorporated by reference herein:

U.S. Pat. No. 5,293,149, issued to Wilson, discloses: A vehicle horn with an electronic solid state energizing circuit is described. The horn has an electromagnet for driving a diaphragm assembly which has a resonant frequency of mechanical vibration. The energizing circuit generates a DC pulse train for energizing the coil of the electromagnet to drive the diaphragm. The circuit has an adjustment for setting the pulse repetition rate of the pulse train substantially equal to the resonant frequency. It also has an adjustment for independently setting the duty cycle of the pulse train. The circuit further includes a compensator for varying the duty cycle inversely with changes in the supply voltage. An electronic power switch is connected in series with the vehicle battery and the horn coil through an unswitched power circuit. A horn switch is connected in an on/off circuit which connects the battery to a control circuit for generating the pulse train and applies it to the electronic power switch.

U.S. Pat. No. 5,109,212, issued to Cortinovis, discloses: A horn comprising a diaphragm, an electromagnet, a transducer to sense the vibrations of the diaphragm and generate a vibration-dependent electrical signal, and a feedback circuit which controls a power supply to the electromagnet. The feedback circuit includes an electronic power circuit (E, IEP) controlled by a control circuit (.mu., F, CCS) arranged to adapt, condition and process the electrical signal from the transducer (S) in such a manner as to automatically determine the frequency and duty cycle for controlling the electronic power circuit (IEP) under the various environmental, electrical feed and constructional tolerance conditions of the horn.

U.S. Pat. No. 6,011,492, issued to Garesche, discloses: A vehicle warning system consisting of a transceiver that augments the audible warnings of standard or emergency vehicles by transmitting and receiving a signal (in conjunction with activation of the typical audible warnings; e.g., horns and/or sirens) which, when received, triggers a visual stimulus to alert drivers to the hazardous condition within the vicinity of their vehicle.

U.S. Pat. No. 5,557,257, issued to Gieffers, discloses: A signaling system is provided that is alternatively operable in programming and operating modes. The signaling system includes a keypad, control head, control unit and a plurality of signaling features selectively activated by the control unit in the operating mode. The system provides for keystrokes to the keypad placing the system in the programming mode and selecting the signaling features to be activated by the control unit in the operating mode.

The inventions heretofore known suffer from a number of disadvantages which include failing to provide users with tone options; requiring complicated steps to allow tone alteration; and being difficult to use, expensive, bulky, and awkward to use.

What is needed is a system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available horn tone systems. Accordingly, the present invention has been developed to provide a horn tone system.

In one embodiment, there is a horn tone system, including one or more of the following: a speaker module configured to broadcast audio; a CPU module in communication with the speaker module and configured to control and store audio information; and a communication module in communication with the CPU module and configured to receive control and audio information.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a system diagram showing a horn tone system in an operational context according to one embodiment of the invention;

FIG. 2 is a system diagram showing a horn tone system in an operational context according to one embodiment of the invention;

FIG. 3 is a block diagram showing modules included in a horn tone system according to one embodiment of the invention;

FIG. 4 is a front elevational view of a steering wheel including portions of a horn tone system according to one embodiment of the invention; and

FIG. 5 is a side perspective view of a vehicle including portions of a horn tone system according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: tone data; tone category metadata and/or like data useful in the operation of the present invention. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

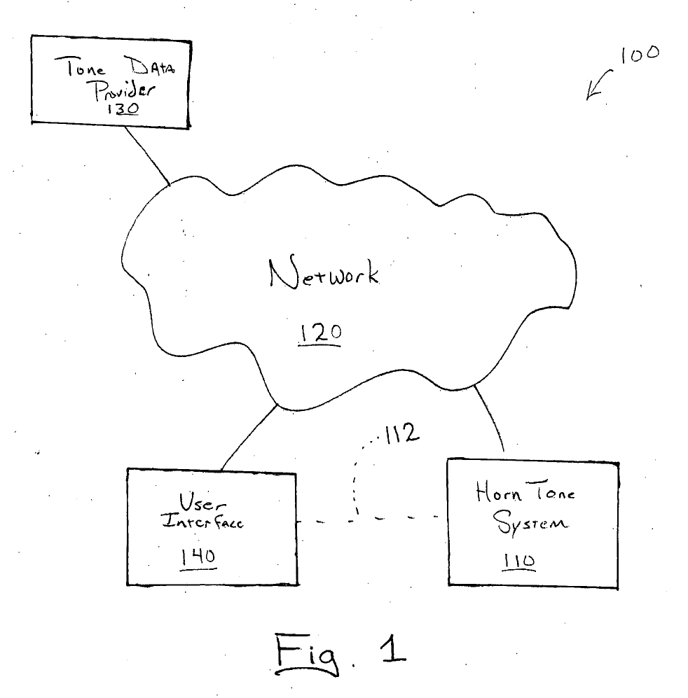

FIG. 1 is a system diagram showing a horn tone system in an operational context according to one embodiment of the invention. There is shown 100 a network 120 (internet, intranet, local area network, wireless connection, combinations thereof and etc.) in communication with a horn tone system 110, a tone data provider module 130, and a user interface module 140. The horn tone system 110 includes modules for communicating with the network such that control and media data may be distributed from the network to the horn tone system 110. Further, a horn tone system may include modules configured to cause playback of such information through a warning system (horn, claxon, amplified speaker and the like) located within a vehicle. Such information may come from the tone data provider 130 and/or the user interface 140. Further, there may be a hard connection 112 (data line, chip, card, and the like) between the user interface 140 and the horn tone system 110 such that a user may directly interface the horn tone system when physically proximate thereto. A tone data provider module may include modules configured to restrict access to data according to a set of rules, such as but not limited to requiring purchase of the information.

In operation, a user may cause audio information (songs, spoken word, sound files, combinations thereof and the like) to be distributed to the horn tone system. Such information may be provided by a tone date provider module. Accordingly, a user may purchase a song or other audio file which may then be distributed to the user's vehicle and played whenever the horn of that vehicle is activated.

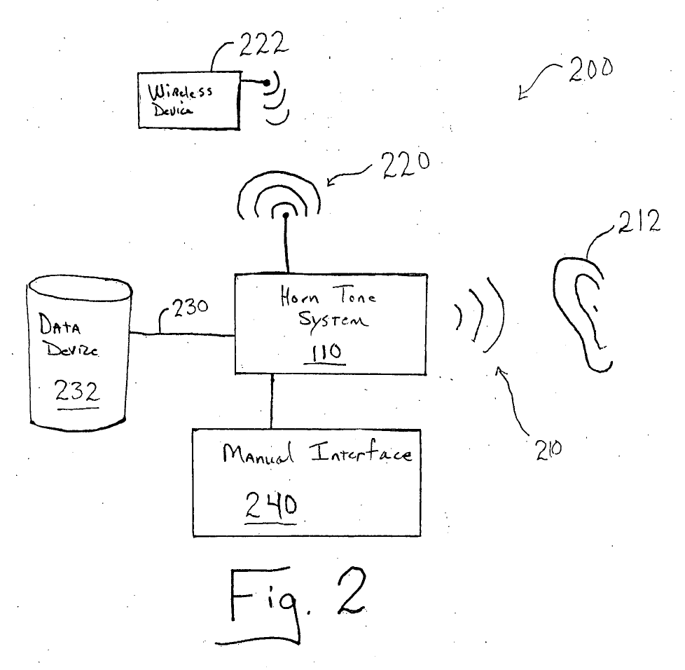

FIG. 2 is a system diagram showing a horn tone system in an operational context according to one embodiment of the invention. There is shown 200 a horn tone system 110 projecting audio 210 to a listeners ear 212. Further, the horn tone system 110 is in communication with a wireless device module 222 (PDA, cell phone, and the like) through a wireless connection (IR, RF, magnetic induction, combinations thereof, and the like); to a data device module 232 (chip, data card, CD, and the like) through a physical connection 230 (wire, mating surface, socket, and the like); and to a manual interface module 240 (keypad, touch-screen, buttons, toggles, switches, combinations thereof, and the like).

In operation, a user may distribute audio information through one or more of the illustrated modules. Further, a user may deliver control information to one or more of the modules through one or more of the modules. Thereby a user may cause desired audio information to be projected as sound at a desired time.

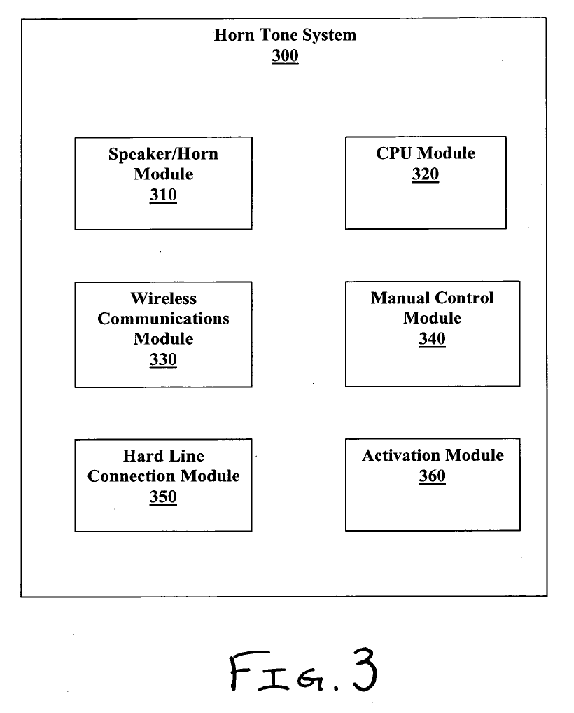

FIG. 3 is a block diagram showing modules included in a horn tone system according to one embodiment of the invention. In particular, the illustrated horn tone system 300 includes a speaker/horn module 310, a CPU module 320, a wireless communications module 330, a manual control module 340, a hardline connection module 350, and an activation module 360.

The illustrated speaker/horn module 310 is configured to project sound at a substantially loud volume (such that audio may be heard by people in other vehicles). Such may include data connection devices to connect the speaker/horn module 310 to other portions of the system. Also included may be a speaker, claxon, horn, or other device for loudly projecting sound.

The illustrated CPU module 320 is configured to facilitate control and communication among other modules. The CPU module may include a central processing unit and/or other computing modules as are commonly known in the art (bus, memory, RAM, ROM, and the like) that may promote control and communication among modules.

The illustrated wireless communication module 330 is configured to enable the horn tone system to communicate with other devices/modules that may not be physically proximate the system. There may be an RF, IR, magnetic induction or other wireless transmitter and/or receiver. The wireless protocols and systems sold under the commonly known trade-name Bluetooth® are non-limiting examples.

The illustrated manual control module 340 is configured to allow a proximate user to cause control information to be distributed to one or more modules. Non-limiting examples of control information include changeaudiofile( ), volumeup( ), volumedown( ), and the like. Such may be embodied in buttons, toggles, switches, and the like. Such may be disposed on a surface located within reach of a driver of a vehicle, such as but not limited to a front portion of a steering wheel.

The illustrated hardline connection module 350 is configured to permit a user to provide control information and/or media information through a physical connection. Such may be a USB port, a Firewire port, a memory card socket, combinations thereof, and the like.

The illustrated activation module 360 is configured to allow a user to activate playback of media information through the speaker/horn module 310. In one non-limiting example, such is a push button disposed on a steering wheel and configured to supply power to a speaker/horn module only when the button is pressed.

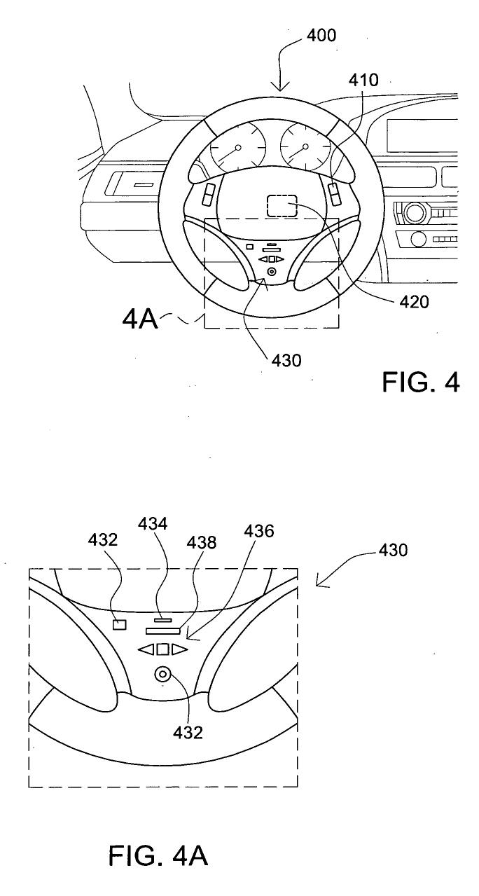

FIG. 4 is a front elevational view of a steering wheel including portions of a horn tone system according to one embodiment of the invention. There is shown a steering wheel 400 of a car having a horn button 410 accessibly dispose thereon, a central processing unit 420 disposed within the steering wheel, and a control panel 430 on a lower front portion thereof.

The illustrated control panel 430 includes a USB/Firewire port 434, a memory card data port 438, a plurality of push button selection controls 436, and a pair of wireless transponders 432 (one RF and one IR).

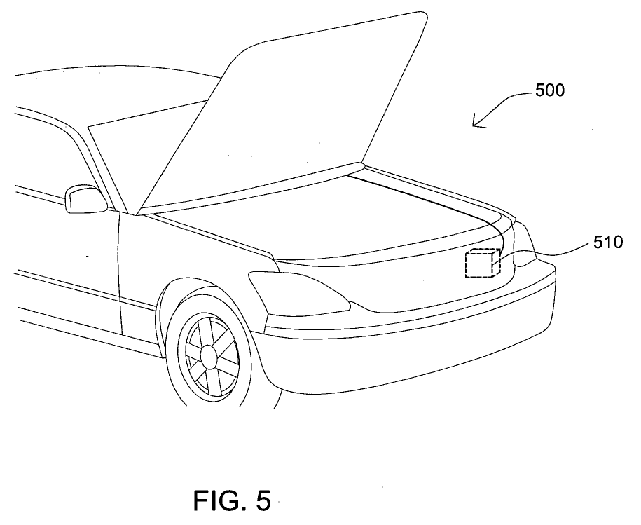

FIG. 5 is a side perspective view of a vehicle including portions of a horn tone system according to one embodiment of the invention. There is shown a front of a vehicle 500 including an amplified speaker 510 (e.g.: a tweeter, or a horn, etc.) disposed therein and configured to broadcast audio waves therefrom.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

The following patents are incorporated herein for their supporting teachings: U.S. Pat. Nos. 6,418,330 to Lee, 7,302,253 to Moody et al., 5,732,074 to Spaur et al., 5,771,438 to Palermo et al., and 6,459,882 to Palermo et al.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A horn tone system, comprising:
a speaker module configured to broadcast audio;
a CPU module in communication with the speaker module and configured to control and store audio information; and
a communication module in communication with the CPU module and configured to receive control and audio information.

2. A horn tone system, consisting of:
a speaker module configured to broadcast audio;
a CPU module in communication with the speaker module and configured to control and store audio information; and
a communication module in communication with the CPU module and configured to receive control and audio information.

3. A horn tone system, comprising:
a speaker module configured to broadcast audio;
a CPU module in communication with the speaker module and configured to control and store audio information; and
a wireless communication module in communication with the CPU module and configured to receive control and audio information.
